(19) United States
(12) Patent Application Publication
(10) Pub. No.: US 2024/0268253 A1
(43) Pub. Date: Aug. 15, 2024

(54) AUTONOMOUS AIR BLOWER SYSTEM

(71) Applicant: AGTONOMY, South San Francisco, CA (US)

(72) Inventors: Timothy Bucher, Geyserville, CA (US); Steven Holmes, Redwood City, CA (US); Aaron Leiba, South San Francisco, CA (US)

(21) Appl. No.: 18/440,752

(22) Filed: Feb. 13, 2024

Related U.S. Application Data
(60) Provisional application No. 63/484,667, filed on Feb. 13, 2023.

(51) Int. Cl. A01B 79/00; A01G 13/08

(52) U.S. Cl. CPC A01B 79/005; A01G 13/08

(57) ABSTRACT

An example method of air circulation among crops may include obtaining an indication of mitigation work to be performed on a crop within an agricultural area using air movement. The method may also include obtaining a navigation path to follow within the agricultural area based on the mitigation work to be performed. The method may further include directing movement of an air blower system along the navigation path. The air blower system may be configured to circulate air among the crops along the navigation path. The method may also include obtaining data from one or more sensors associated with the air blower system while the air blower system is moved along the navigation path. The data may be related to the mitigation work to be performed. The method may further include directing adjustment of an operating condition of the air blower system based on the data.

### CROSS-REFERENCE TO RELATED APPLICATION

This patent application claims the benefit of and priority to U.S. Provisional App. No. 63/484,667 filed Feb. 13, 2023, titled “AUTONOMOUS AIR BLOWER SYSTEM,” which is incorporated in the present disclosure by reference in its entirety.

### FIELD

The present disclosure is generally directed towards an autonomous blower system.

### BACKGROUND

Unless otherwise indicated herein, the materials described herein are not prior art to the claims in the present application and are not admitted to be prior art by inclusion in this section.

Agricultural ventures, including farming, are often associated with intensive operations. In some circumstances, the operations may be intensive due to the operations being performed over large tracts of land and/or relative to a task intensive crop. In some instances, an operator may use a vehicle such as a tractor to reduce the amount of time and/or manual labor used to perform the operations.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In some embodiments, an example method of air circulation among crops may include obtaining an indication of mitigation work to be performed on a crop within an agricultural area using air movement. The method may also include obtaining a navigation path to follow within the agricultural area based on the mitigation work to be performed. The method may further include directing movement of an air blower system along the navigation path. In some embodiments, the air blower system may be configured to circulate air among the crops along the navigation path. The method may also include obtaining data from one or more sensors associated with the air blower system while the air blower system is moved along the navigation path. In some embodiments, the data may be related to the mitigation work to be performed. The method may further include directing adjustment of an operating condition of the air blower system based on the data from the one or more sensors.

These and other aspects, features and advantages may become more fully apparent from the following brief description of the drawings, the drawings, the detailed description, and appended claims.

### BRIEF DESCRIPTION OF THE DRAWINGS

Example embodiments will be described and explained with additional specificity and detail through the use of the accompanying drawings in which:

FIG. 1 is a block diagram of an example environment that may include a blower system;

FIG. 2 is a block diagram of an example blower system;

FIG. 3 is a block diagram of another example blower system;

FIG. 4 illustrates a flowchart of an example method of air circulation among crops; and

FIG. 5 illustrates a block diagram of an example computing system, all arranged in accordance with at least one embodiment of the present disclosure.

### DESCRIPTION OF EMBODIMENTS

Agricultural undertakings, including farming, are often time consuming and of a large scale such that power vehicles and/or equipment provide a great benefit in accomplishing tasks related thereto. For example, some crops may be susceptible to damage by freezing temperatures. To help to reduce the loss of crops to freezing temperature, blowers/fans may be installed to circulate air among the crops to prevent freezing of the crops. These blowers are typically stationary and installed in a single location to cover a particular area. The area covered by a single blower may be susceptible to one or more micro-climates. As a result, the blower may provide sufficient freezing protection for some portion of the particular area and not provide sufficient freezing protection for other portions of the particular area.

Aspects of the present disclosure address these and other shortcomings of prior approaches by a mobile blower that is configured to circulate air among crops. In these and other embodiments, the circulation of air among the crops may assist in providing freezing protection. Alternately or additionally, the circulation of air may assist in drying crops to avoid mildew growth, circulation of air to push smoke, such as from wildfires, away from the crops, and/or circulation of air to assist in control of pests. In some embodiments, the mobile blower may be autonomous. A blower may be autonomous based on being controlled by an autonomous vehicle, such as an autonomous tractor. Alternately or additionally, the blower may be an independent autonomous blower. The use of the term “autonomous blower” in this disclosure may indicate either an independent autonomous blower or a blower controlled by an autonomous vehicle.

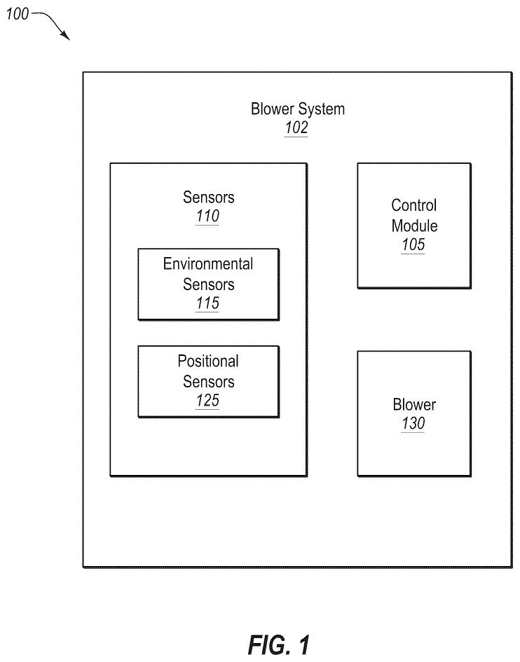

FIG. 1 is a block diagram of an example environment 100 that includes a blower system 102, in accordance with at least one embodiment described in the present disclosure. The blower system 102 may include a control module 105, sensors 110, and a blower 130. The sensors 110 may include environmental sensors 115 and positional sensors 125.

The blower system 102 may be configured to blow air. The blower system 102 may include a motor and one or more blades that pulls air from the ambient air and pushes the air in a particular direction. In these and other embodiments, the blades may blow the air through one or more nozzles in a particular direction. The blower system 102 may be configured to blow air at varying speeds and varying amounts of air. For example, the blower system 102 may blow air at speeds ranging from 5, 10, 30, 50, 75, 100, 125, 150, 180, 200, 230, 250, or 280 miles per hour, among other speeds.

In some embodiments, the blower system 102 may be configured to circulate air among crops in an agriculture setting. For example, the blower system 102 may be configured to blow air among live crops that are actively growing. As an example, the air circulation may be used to dry the crops or reduce a risk of freezing of the crops. Alternately or additionally, the air circulation may be used to remove particles suspended in the air from among the crops, such as smoke from a wildfire. Alternately or additionally, the air circulation may be used to help to control insects or other pests that may affect the crops. For example, the air circulation may be used to move the pest away from the crops or deter the pests from interacting with the crops. Alternately or additionally, the air circulation may be used to assist in pollination by facilitating the movement of pollen between crops.

In some embodiments, the blower system 102 may be a mobile blower system that is able to move through an agriculture area and circulate air in different areas of the agricultural area for different amounts of time. For example, the blower system 102 may be configured to circulate air in first portions of an agriculture area for a first amount of time and configured to circulate air in second portions of the agricultural area for a second amount of time. In these and other embodiments, the blower system 102 may include a drive train, such as a motor and multiple wheels coupled to the motor. In these and other embodiments, the motor may operate to turn the wheels to move the location of the blower system 102 through the agriculture area.

In some embodiments, the blower system 102 may be an independent mobile device that is configured to move through an agricultural area and that includes a motor to blow air for air circulation among crops. Alternately or additionally, the blower system 102 may be divided among one or more devices. For example, the blower system 102 may include a tractor and an air blower implement that is attached to the tractor. In these and other embodiments, the air blower may be controlled and/or powered by the tractor. For example, the tractor may be the same or similar as the tractor described in 17/647,723 (U.S. Patent Publication No. US 2022/0219697) entitled MULTI-OPERATIONAL LAND DRONE, which is incorporated herein in its entirety.

In the present disclosure, the term “tractor” may refer to an agricultural tractor and/or other power equipment or vehicles that may be used in an agricultural setting. Alternatively, or additionally, the term “tractor” may include any power vehicle that may be configured to operate autonomously, which may further be used in the agricultural setting or any other applicable setting. Further, while discussed in primarily an agricultural setting, some embodiments of the present disclosure may be used in other settings, such as mining, construction, and/or other locales where large machinery, such as a tractor, may be beneficial.

In some embodiments, the control module 105 may be configured to control the blower system 102. For example, the control module 105 may be configured with one or more algorithms for partial or full autonomous control of the blower system 102. For example, the control module 105 may control a location of the blower system 102 within an agricultural area. In these and other embodiments, the control module 105 may direct the blower system 102 to move among different locations within the agricultural area. Alternately or additionally, the control module 105 may be configured to control the blower 130. In these and other embodiments, the control module 105 may be configured to control operation of the blower 103, such as an open and off state of the blower, a direction of the blower 130, and/or a speed of operation of the blower 130 that may affect an amount of air flow per an amount of time generated by the blower 130.

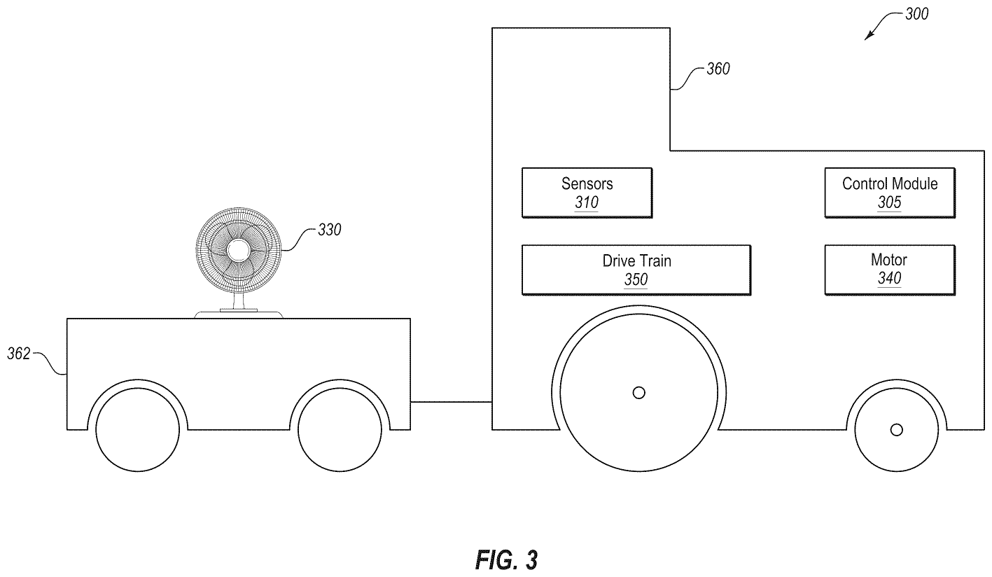

In some embodiments, the control module 105 may be coupled to the sensors 110 and configured to obtain input from the sensors 110. In these and other embodiments, the control module 105 may be configured to control the blower system 102 based on the input from the sensors. For example, the environmental sensors 115 and/or the positional sensors 125 may be configured to transmit acquired data to the control module 105. Alternately or additionally, the control module 105 may be configured to communicate with and/or obtain data from other devices and sensors. For example, the implement control module 105 may obtain and use data generated by a weather system, a crop view system, drone, satellite, or some other system. In some embodiments, the operation of the implement control module 105 may be performed by a computing system, such as the computing system 300 of FIG. 3.

In some embodiments, the environmental sensors 115 may be configured to detect environmental conditions in which the blower system 102 is disposed. The environmental sensors 115 may include one or more of digital cameras, infrared sensors, radar sensors, lidar sensors, moisture sensors, weather sensors, soil sensors, and/or other environmental sensors. The weather sensors may be configured to measure one or more of temperature, barometric pressure, precipitation, humidity, solar radiation, wind speed, wind direction, lightning strike count, and/or lightning strike distance. In some embodiments, the environmental sensors 115 may generate environmental data related to the environment associated with the blower system 102. In some embodiments, the implement control module 105 may be configured to obtain the environmental data from the environmental sensors 115.

In some embodiments, the control module 105 may obtain positional data from the positional sensors 125. The positional data may indicate a position of the blower system 102 with respect to a map or some other reference point. For example, the positional data may indicate a position of the blower system 102 with respect to crops or some other structure near to crops. In some embodiments, the positional sensors 125 may include one or more of a GPS, one or more accelerometers, and/or one or more gyroscopes.

In some embodiments, the control module 105 may be configured to position and/or navigate the blower system 102 to perform mitigation work, among other work. The mitigation work may include mitigating freezing of crops, mitigating molding of crops from excess moisture, mitigating particle accumulation among the crops, mitigating pest infestations. Other work performed by the blower system 102 may include assisting in pollination among other work that may involve movement of air.

In some embodiments, the control module 105 may be configured to control work of the blower system 102 based on feedback information from the sensors 110. For example, the control module 105 may accept data from the sensors 110. In response to the data from the sensors, the control module 105 may adjust one or more aspects of the blower system 102. For example, the control module 105 may adjust an on and off state of the blower, a direction of the blower 130, an air flow speed of the blower 130 that may affect an amount of air flow per an amount of time generated by the blower 130, and/or one or more movement patterns for blowing the air. The movement patterns for blowing the air indicate one or more directions in which the blower 130 directs air as the blower system 102 moves or is stationary. For example, the movement patterns may be different based on any movement of the blower system 102, a speed of the blower system 102, the mitigation work being performed, a crop associated with the mitigation work, feedback from the sensors, among other information. For example, the movement pattern may include blowing air in consistent location as the blower system 102 moves or blowing air in a circular pattern, a figure eight pattern, a square pattern, a back-and-forth pattern horizontally, vertically, or at some other angle, among other patterns. For example, the blower 130 may be coupled to an articulating arm or some other mechanism to allow the blower 130 to move in different patterns or to be directed at different angles away from the body of the blower system 102.

In some embodiments, the control module 105 may be further configured to adjust a speed of movement of the blower system 102. In these and other embodiments, the control module 105 may adjust the air flow speed of the blower 130, a direction of the blower 130, and/or a movement pattern of the blower 130. In some embodiments, the adjustments made by the control module 105 may be dependent on each other. For example, the speed of the blower system 102 and the air flow speed of the blower 130 may be dependent variables such that an adjustment of one may result in an adjustment of the other. For example, the faster the blower system 102 moves the faster the air flow speed of the blower 130 may be set. As another example, the movement pattern and/or direction of the blower 130 may be adjusted based on the air flow speed and/or the speed of the blower system 102.

In some embodiments, the control module 105 may be configured to adjust operation of the blower system 102 based on data from the sensors 110, historical information, data from other sources, instructions from a user, among other types of data. For example, the sensors 110 may indicate a type of plant being affected by the air flow. Based on the type of plant, the control module 105 may adjust the operation of the blower system 102 by adjusting the direction of air being blown, a movement pattern of the blower 130, an air speed of the air being blown, the speed of the blower system 102, among other adjustments to the blower system 102. As another example, the sensors 110 may determine an increase of insects on a particular plant or area of a crop. Based on the increase of bugs, the control module 105 may adjust the operation of the blower system 102 by adjusting a movement pattern of the blower 130, an air speed of the air being blown, and the speed of the blower system 102, among other adjustments to the blower system 102 to help to decrease the number of insects.

As another example, the control module 105 may commence or adjust mitigation work based on data from the sensors 110, historical information, data from other sources, instructions from a user, among other types of data. For example, the blower system 102 may be idle and accepting information from the sensors 110. In response to the information indicating a threshold being satisfied, the control module 105 may direct commencement of mitigation work. The threshold may be determined based on user input, historical information, weather data, among other data.

In some embodiments, to commence the mitigation work, the control module 105 may determine multiple components of the mitigation work. For example, the components of the mitigation work may include a navigation path, a speed of the blower system 102, the air speed of the blower system 102, movement pattern and/or direction for blowing the air among other components of the mitigation work. Alternately or additionally, the control module 105 may obtain set values for some of the components and determine values for other of the components based on data obtained by the control module 105.

In some embodiments, the control module 105 may dynamically adjust the mitigation work based on changes to the data being received. For example, a change in the weather data may cause a change in the mitigation work being performed. For example, the control module 105 may adjust a location, speed, air speed, blower direction, navigation route, among other factors based on the change in data being received and processed.

Multiple examples of specific types of mitigation work that may be performed by the blower system 102 are now provided.

As an example, when the blower system 102 is configured to help to prevent freezing of a crop, the control module 105 may determine the portions of an agricultural area that may be more susceptible to freezing. For example, the control module 105 may analyze a topographical map of the agricultural area. Based on the analysis, the control module 105 may identify the areas of the agricultural area that may be more susceptible to freezing based on their elevation and surrounding terrain. Alternately or additionally, the control module 105 may obtain the information regarding the susceptible areas from another device, such as a server or information system that is not part of the blower system 102.

Alternately or additionally, the control module 105 may determine areas that may be susceptible to freezing based on historical information. For example, the agricultural area may include multiple micro-climates. Based on historical environmental data, the control module 105 may determine those areas of the agricultural area that may be more likely to freeze before others. For example, one area of the agricultural area may be historically colder than other areas of the agricultural area.

In these and other embodiments, the control module 105 may use forecasted weather to predict the areas of the agricultural area that may be susceptible to freezing. For example, given a forecast of 34 degrees Fahrenheit, the control module 105 may determine that certain areas may be susceptible to freezing and other areas may not be susceptible to freezing. As another example, the control module 105 may determine that all the agricultural area may be susceptible to freezing based on the forecasted weather.

As another example, when the blower system 102 is configured to help to reduce growth of mold on a crop due to moisture, the control module 105 may determine the portions of an agricultural area that may be more susceptible to mold growth. In these and other embodiments, the control module 105 may determine portions of the agricultural area that may be isolated from a sunlight, breezes, or other forces that may assist in drying a crop. In these and other embodiments, the control module 105 may determine the portions of the agricultural area based on map data, historical data, and/or sensor data.

In some embodiments, after determining locations of the agricultural area for mitigation work, the control module 105 may obtain a navigation path to perform the mitigation work. In these and other embodiments, the control module 105 may obtain a navigation path to perform the mitigation work from a database with historical paths. Alternately or additionally, the control module 105 may obtain a navigational path from a device with a user interface that obtain user input to describe the navigation path.

As another example, the control module 105 may obtain a navigational path based on determining the navigation path. In these and other embodiments, the control module 105 may determine a path through the crops susceptible to mold that allows the blower system 102 to mitigate the mold growth on the crops. In these and other embodiments, the control module 105 may use map information and other information about an agricultural area to determine the path through the crops. As an example, the control module 105 may chart a path down every row or every other row of grape vines susceptible to mold growth. In these and other embodiments, the control module 105 may navigate the blower system 102 through the rows such that the blower 130 may come into close proximity to the crop to allow for drying of moisture from the clusters of grapes on the vines. The control module 105 may use information from the sensors 110 to navigate the blower system 102 through the rows.

In these and other embodiments, the control module 105 may obtain information from the environmental sensors 115 to determine a specific location of the crops at which to direct the blower 130, such as clusters of grapes on a vine. In these and other embodiments, an amount of time the control module 105 may direct the blower at an individual crop may be based on feedback from the sensors, an amount of crop requiring mold mitigation, environmental data, and other factors. In these and other embodiments, the control module 105 may start the blower 130 based on the blower 130 being directed at crops and stop the blower 130 when crops are not present or crops are present that do not need drying or may be damaged from blown air. In these and other embodiments, the control module 105 may reduce damage to crops and/or reduce use of resources by starting and stopping the blower 130.

As another example, the control module 105 may determine a path through the agricultural area that allows the blower system 102 to circulate the area to mitigate freezing of crops. The navigation path for mitigating freezing may cause the blower system 102 to stop between rows and blow air through the individual rows. In these and other embodiments, the blower system 102 may not enter the individual rows as air circulation from the ends of the rows may circulate the air sufficiently to mitigate freezing of the crops. In these and other embodiments, the control module 105 may start the blower 130 based on the blower 130 being directed at a row. Between the rows, the control module 105 may stop the blower 130. In these and other embodiments, an amount of time spent circulating air at each row may be based on environmental factors, such as a current air temperature, humidity, an amount of frost mitigation to perform, and other factors. For example, the control module 105 may control the blower to circulate air in a row until the air temperature in the row satisfies a threshold and/or until a change in the air temperature satisfies a threshold.

In some embodiments, the control module 105 may use data from the environmental sensors 115 to determine a speed of the blower 130, a length of time for blowing in a particular area, and a speed for movement of the blower system 102, among other operations of the blower system 102. For example, the control module 105 may obtain environmental data from the environmental sensors 115 to determine if the circulation of air is being effective to mitigate freezing of the crops given current operational conditions of the blower system 102. In response to determining the circulation of air is not being effective to mitigate freezing, the control module 105 may adjust one or more operating conditions of the blower system 102. For example, in response to determining from the environmental sensors 115 that the temperature is not satisfying a threshold, the control module 105 may adjust one or more operating conditions of the blower system 102. For example, the control module 105 may cause the blower system 102 to move at a slower pace, to maintain a paused position for longer periods of time, to increase a speed of air movement, and to move in a different navigational pattern, such as down rows, among other adjustments to the operating conditions of the blower system 102. The adjustments to the operating conditions of the blower system 102 may assist in causing the temperature to satisfy the threshold. In these and other embodiments, the threshold may be selected based on the crop growing in the agricultural area in which the blower system 102 is working and and/or a stage of development of the crop growing in the agricultural area.

As another example, the control module 105 may determine a path through the agricultural area that allows the blower system 102 to circulate the area to mitigate particulate accumulation among the crops, such as particulates from wildfire smoke. In some embodiments, the control module 105 may use data from the environmental sensors 115 to determine a speed of the blower 130, a length of time for blowing in a particular area, and a speed for movement of the blower system 102, among other operations of the blower system 102. For example, the control module 105 may obtain environmental data from the environmental sensors 115, such as a camera to determine a number of particulates in the air and/or on the crops. In these and other embodiments, the control module 105 may direct the blower to circulate air in a particular area until the number of particulates in the air and/or on the crops satisfies a threshold. In these and other embodiments, the threshold may be selected based on the crop growing in the agricultural area in which the blower system 102 is working and/or a stage of development of the crop growing in the agricultural area.

As another example, the control module 105 may determine a path through the agricultural area that allows the blower system 102 to circulate the area to mitigate a number of insects among the crops. In some embodiments, the control module 105 may use data from the environmental sensors 115 to determine a speed of the blower 130, a length of time for blowing in a particular area, and a speed for movement of the blower system 102, among other operations of the blower system 102. For example, the control module 105 may obtain environmental data from the environmental sensors 115, such as a camera to determine a number of insects within a particular area. In these and other embodiments, the control module 105 may direct the blower to circulate air in a particular area until the number of insects in a particular area satisfies a threshold. In these and other embodiments, the threshold may be selected based on the crop growing in the agricultural area in which the blower system 102 is working, a stage of development of the crop growing in the agricultural area, and/or a type of insect being controlled.

As another example, the control module 105 may determine a path through the agricultural area that allows the blower system 102 to circulate the area to assist in pollination among the crops. In some embodiments, the control module 105 may use data from the environmental sensors 115 to determine a speed of the blower 130, a length of time for blowing in a particular area, and a speed for movement of the blower system 102, among other operations of the blower system 102. For example, the control module 105 may obtain environmental data from the environmental sensors 115, such as a camera, to determine a how much pollen is in the air or on a plant surface. In these and other embodiments, the control module 105 may direct the blower to circulate air in a particular area until an amount of pollen in a particular area satisfies than a threshold. In these and other embodiments, the threshold may be selected based on the crop growing in the agricultural area in which the blower system 102 is working and/or a stage of development of the crop growing in the agricultural area.

In some embodiments, the control module 105 may use data from the sensors 110 such as a camera, to minimize damage to the crops due to the circulation of air by the blower system 102. For example, the control module 105 may determine a state of the crops. Based on the state of the crops, the control module 105 may place limits on a speed of the blower 130, a length of time for blowing in a particular area, and a speed for movement of the blower system 102, among other operations of the blower system 102, to assist in reducing damage to the crops. In these and other embodiments, the control module 105 may determine operations of the blower system 102 to achieve mitigation work as well as a to reduce damage to the crops. In these and other embodiments, the control module 105 may use feedback from the sensors 110 to adjust the operations of the blower system 102 to reduce damage to the crops. For example, the control module 105 may obtain data from a sensor that a particular air speed or distance between the blower 130 and the crop may be causing unwanted damage to the crop when performing mitigation work. In these and other embodiments, the control module 105 may adjust the operations of the blower system 102 to reduce the damage and still perform the mitigation work. For example, the control module 105 may reduce an air speed and increase a duration of air circulation in a particular area to reduce damage to the crops while mitigating air particulates.

Modifications, additions, or omissions may be made to the environment 100 without departing from the scope of the present disclosure. For example, the environment 100 may include any number of other components that may not be explicitly illustrated or described. For example, another device and/or system, such as a remote device or server, may obtain data from the control module 105, make determinations as described in this disclosure, and provide data back to the control module 105 to allow the blower system 102 to implement the determinations made by the other device and/or system. In these and other embodiments, the blower system 102 may communicate with the other system. Alternately or additionally, the control module 105 may obtain data from another system or device, such as historical data. Alternately or additionally, one or more of the sensors 110 may not be part of the blower system 102 and the control module 105 may obtain data from the one or more of the sensors 110 via a communication link.

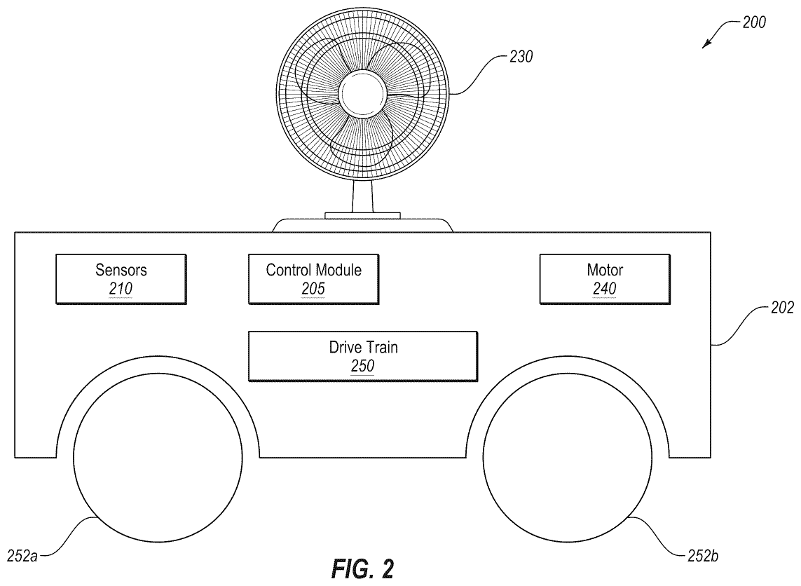

FIG. 2 illustrates an example blower system 200, in accordance with at least one embodiment described in the present disclosure. The blower system 200 may include a frame 202 that houses a control module 205, sensors 210, a motor 240, and a drive train 250. A blower 230 may be coupled to the frame 202. The frame 202 may be coupled to first and second wheels 252a and 252b, referred to collectively as the wheels 252.

In some embodiments, the sensors 210 and the control module 205 may be analogous to the sensors 110 and the control module 105 of FIG. 1 and thus some or all the discussion with respect to the sensors 110 and the control module 105 may be applicable to the sensors 210 and the control module 205.

In some embodiments, the motor 240 may be any type of motor that may be configured to generate electrical or mechanical energy. The motor 240 may be coupled to the drive train 250 and configured to supply the electrical or mechanical energy to the drive train 250. The drive train 250 may be coupled to the wheels 252 and the blower 230. In these and other embodiments, the drive train 250 may supply electrical or mechanical energy to the blower 230 and or the wheels 252.

In some embodiments, the control module 205 may be coupled to the motor 240 and/or the drive train 250. In these and other embodiments, the control module 205 may direct how electrical or mechanical energy is generated by the motor 240. In these and other embodiments, the control module 205 may direct how electrical or mechanical energy is provided to the wheels 252 and/or the blower 230 by the drive train 250. In these and other embodiments, the control module 205 may control the drive train 250 to control a speed of the blower system 200.

In some embodiments, the control module 205 may control the blower 230. For example, the control module 205 may control an air speed generated by the blower 230. Alternately or additionally, the control module 205 may control a direction in which air is blown by the blower 230. Alternately or additionally, the control module 205 may control a pattern in which the air is blown by the blower 230.

In some embodiments, the blower 230 may include one or more blades or turbines configured to generate air movement at varying speeds. The blower 230 may be configured to move in multiple directions. For example, the blower 230 may be configured to rotate and include an adjustable elevation. In these and other embodiments, the blower 230 may move in multiple different patterns.

In some embodiments, the control module 205 may be configured to run software to cause the blower system 200 to perform operations. In these and other embodiments, the software may include instructions to cause the operation of the blower system 200 as described in this disclosure. Alternately or additionally, the control module 205 may be configured to obtain instructions from an external server. In these and other embodiments, the control module 205 may provide data to the external server and obtain instructions regarding operation of the blower system 200.

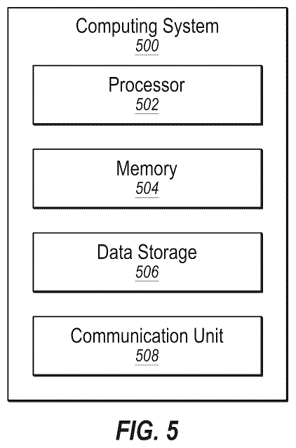

Modifications, additions, or omissions may be made to the blower system 200 without departing from the scope of the present disclosure. For example, the blower 230 may be directly coupled to the motor 240. Alternately or additionally, the blower system 200 may include additional components. For example, the blower system 200 may include further processing components such as those illustrated in FIG. 5. As another example, the blower system 200 may include multiple blowers 230. In these and other embodiments, each of the blower 230 may be independently controlled. For example, a first blower may operate at a first speed and in a first pattern and a second blower may operate at a second speed and in a second pattern.

FIG. 3 illustrates an example blower system 300, in accordance with at least one embodiment described in the present disclosure. The blower system 300 may include a tractor 360 and a blower implement 362. The tractor 360 may include a control module 305, sensors 310, a motor 340, and a drive train 350. The blower implement 362 may include a blower 330.

In some embodiments, the control module 305, the sensors 310, the drive train 350, the motor 340, and/or the blower 330 may be analogous to the control module 205, the sensors 210, the drive train 250, the motor 240, and/or the blower 230 of FIG. 2, thus some or all the discussion with respect to the control module 205, the sensors 210, the drive train 250, the motor 240, and/or the blower 230 may be applicable to the control module 305, the sensors 310, the drive train 350, the motor 340, and/or the blower 330.

In some embodiments, the motor 340 may be used to provide electrical or mechanical energy for the tractor 360. In these and other embodiments, the control module 305 may control a direction and/or speed of the tractor 360 via an interface with the drive train 350 and/or the motor 340.

In some embodiments, the blower implement 362 may be mechanically coupled to the tractor 360. For example, the blower implement 362 may be coupled to the tractor 360 through a towing hitch. In these and other embodiments, the tractor 360 may tow the blower implement 362 and/or provide energy to the blower implement 362 to operate the blower 330. For example, the tractor 360 may provide energy to the blower implement 362 via the drive train 350. In some embodiments, the control module 305 may provide instructions to the blower implement 362 to adjust the operation of the blower 330 as described in this disclosure.

Modifications, additions, or omissions may be made to the blower system 300 without departing from the scope of the present disclosure. For example, the sensors 310 and/or the control module 305 may be part of the blower implement 362. In these and other embodiments, the tractor 360 may provide energy to the blower implement 362 to operate the sensors 310 and the control module 305. Alternately or additionally, the tractor 360 may include some of the sensors 310 and the blower implement 362 may include additional sensors.

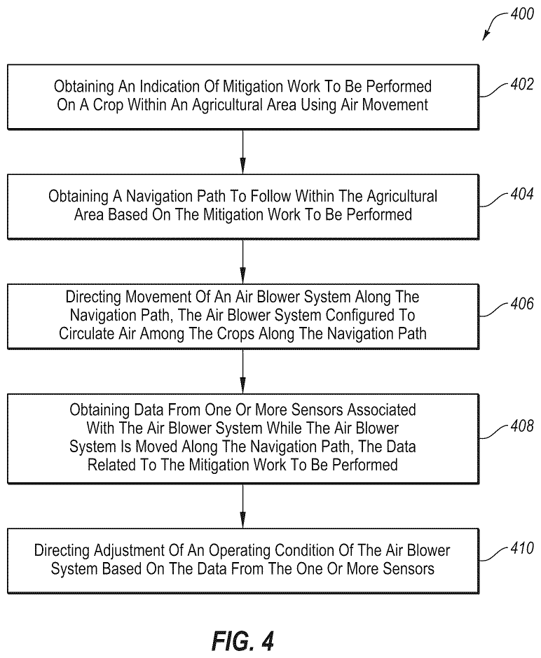

FIG. 4 illustrates a flowchart of an example method 400 of an operator directed autonomous system, according to one or more embodiments of the present disclosure. Each block of method 400, described herein, comprises a computing process that may be performed using any combination of hardware, firmware, and/or software. For instance, various functions may be carried out by a processor executing instructions stored in memory. The method 400 may also be embodied as computer-usable instructions stored on computer storage media. The method 400 may be provided by a standalone application, a service or hosted service (standalone or in combination with another hosted service), or a plug-in to another product, to name a few. In addition, the method 400 is described, by way of example, with respect to the environment of FIG. 1. However, these methods may additionally or alternatively be executed by any one system, or any combination of systems, including, but not limited to, those described herein. In these or other embodiments, one or more operations of the method 400 may be performed by one or more computing devices, such as that described in further detail below with respect to FIG. 4.

The method 400 may begin at block 402 where obtaining an indication of mitigation work to be performed on a crop within an agricultural area using air movement may be performed. The indication may be obtained by an air blower system. In these and other embodiments, the air blower system may be a machine, such as an autonomous or semi-autonomous tractor and an air blower implement and an independent air blower system specifically designed for movement and blowing air. In these and other embodiments, the indication may be obtained by the tractor when the tractor is or is not coupled to the air blower implement. In these and other embodiments, when the tractor is not coupled to the air blower implement, the tractor may be configured to obtain the air blower implement to configure the tractor as the air blower system to perform the mitigation work. For example, the tractor may remove a current implement coupled to the tractor and couple the air blower implement. In these and other embodiments, the tractor may perform the change autonomously or semi-autonomously.

In some embodiments, the indication may be obtained by the air blower system from another device. For example, a server may provide the indication to the air blower system independent of human interaction based on weather information and/or other data. Alternately or additionally, a person associated with the agricultural area may provide the indication. Alternately or additionally, the air blower system may determine the indication based on a weather information and/or other data.

At block 404, obtaining a navigation path to follow within the agricultural area based on the mitigation work to be performed may be performed. In these and other embodiments, the air blower system may obtain the navigation path by determining the navigation path. Alternately or additionally, the air blower system may obtain the navigation path from the user.

At block 406, directing movement of the air blower system along the navigation path, the air blower system configured to circulate air among the crops along the navigation path may be performed. In these and other embodiments, the air blower system may provide navigational instructions to direct movement of the air blower system along the navigation path. Alternately or additionally, directing movement of the air blower system may include determining when and how long to stop, a speed of movement, and other movements to be performed during the mitigation work.

At block 408, obtaining data from one or more sensors associated with the air blower system while the air blower system is moved along the navigation path, the data related to the mitigation work to be performed. The air blower system may include the sensors. For example, the tractor may include the one or more sensors. The sensors may be environment sensors configured to determine a temperature or other environmental data. Alternately or additionally, the sensors may be imaging sensors configured to detect the crop to which the air is to be directed.

At block 410, directing adjustment of an operating condition of the air blower system based on the data from the one or sensors. In some embodiments, the adjustment to the operating condition may include a direction to blow the air, a speed, a navigation path to follow, an amount of time to stop movement of the air blower system, an amount of time to blow air in a particular direction, a speed of the air, among other operating conditions of the air blower system. For example, the adjustment to the operating condition may be based on the data from the one or more sensors satisfying a threshold. For example, in response to an air temperature being higher than a threshold, such as 34 degrees Fahrenheit, the air blower system may adjust a current operation and move from a current position to another position to circulate air. In these and other embodiments, the air blower system may move to another position along the navigation path.

Modifications, additions, or omissions may be made to the method 400 without departing from the scope of the present disclosure. For example, although illustrated as discrete blocks, various blocks of the method 400 may be divided into additional blocks, combined into fewer blocks, or eliminated, depending on the desired implementation. For example, the method 400 may not include the blocks 402, 408, and/or 410. For example, the method 400 may include blocks 402, 404, and 406.

As another example, the method 400 may further include obtaining other non-sensor data. In these and other embodiments, the adjustment of the operating condition of the air blower system may be further based on the non-sensor data. In these and other embodiments, the non-sensor data may include one or more of: weather data, historical data, and positional data.

As another example, the method 400 may further include determining, by the air blower system, the mitigation work to be performed on the crop based on obtained data. In these and other embodiments, the indication of the mitigation work to be performed may be obtained from the determination.

As another example, the method 400 may further include determining, by the air blower system, the navigation path to follow within the agricultural area based on the mitigation work to be performed.

FIG. 5 illustrates an example computing system 500 that may be used for an operator directed autonomous system, in accordance with at least one embodiment of the present disclosure. The computing system 500 may be configured to implement or direct one or more operations associated with an operator directed autonomous system, which may include operation of the blower system 102 and/or the associated operations thereof. The computing system 500 may include a processor 502, memory 504, data storage 506, and a communication unit 508, which all may be communicatively coupled. In some embodiments, the computing system 500 may be part of any of the systems or devices described in this disclosure.

For example, the computing system 500 may be configured to perform one or more of the tasks described above with respect to the blower system 102, 200, 300, and/or the method 400.

The processor 502 may include any computing entity, or processing device including various computer hardware or software modules and may be configured to execute instructions stored on any applicable computer-readable storage media. For example, the processor 502 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 502 may include any number of processors distributed across any number of networks or physical locations that are configured to perform individually or collectively any number of operations described herein.

In some embodiments, the processor 502 may be configured to interpret and/or execute program instructions and/or process data stored in the memory 504, the data storage 506, or the memory 504 and the data storage 506. In some embodiments, the processor 502 may fetch program instructions from the data storage 506 and load the program instructions in the memory 504. After the program instructions are loaded into memory 504, the processor 502 may execute the program instructions.

For example, in some embodiments, the processor 502 may be configured to interpret and/or execute program instructions and/or process data stored in the memory 504, the data storage 506, or the memory 504 and the data storage 506. The program instruction and/or data may be related to an operator directed autonomous system such that the computing system 500 may perform or direct the performance of the operations associated therewith as directed by the instructions. In these and other embodiments, the instructions may be used to perform the method 400 of FIG. 4.

The memory 504 and the data storage 506 may include computer-readable storage media or one or more computer-readable storage mediums for carrying or having computer-executable instructions or data structures stored thereon. Such computer-readable storage media may be any available media that may be accessed by a computer, such as the processor 502.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 502 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 508 may include any component, device, system, or combination thereof that is configured to transmit or receive information over a network. In some embodiments, the communication unit 508 may communicate with other devices at other locations, the same location, or even other components within the same system. For example, the communication unit 508 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 508 may permit data to be exchanged with a network and/or any other devices or systems described in the present disclosure.

Modifications, additions, or omissions may be made to the computing system 500 without departing from the scope of the present disclosure. For example, in some embodiments, the computing system 500 may include any number of other components that may not be explicitly illustrated or described. Further, depending on certain implementations, the computing system 500 may not include one or more of the components illustrated and described.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method of air circulation among crops, the method comprising:
obtaining an indication of mitigation work to be performed on a crop within an agricultural area using air movement;
obtaining a navigation path to follow within the agricultural area based on the mitigation work to be performed;
directing movement of an air blower system along the navigation path, the air blower system configured to circulate air among the crops along the navigation path;
obtaining data from one or more sensors associated with the air blower system while the air blower system is moved along the navigation path, the data related to the mitigation work to be performed; and
directing adjustment of an operating condition of the air blower system based on the data from the one or more sensors.

2. The method of claim 1, wherein the operating condition includes one or more of: an air speed of the air configured to circulate, a speed of movement of the air blower system, a direction of the air, and a pattern of air movement.

3. The method of claim 1, further comprising obtaining other non-sensor data, wherein the adjustment of the operating condition of the air blower system is further based on the non-sensor data.

4. The method of claim 3, wherein the non-sensor data includes one or more of: weather data, historical data, and positional data.

5. The method of claim 1, further comprising determining, by the air blower system, the mitigation work to be performed on the crop based on obtained data, wherein the indication of the mitigation work to be performed is obtained from the determination.

6. The method of claim 1, wherein the indication of the mitigation work is obtained from a user.

7. The method of claim 1, further comprising determining, by the air blower system, the navigation path to follow within the agricultural area based on the mitigation work to be performed.

8. One or more non-transitory computer-readable mediums configured to store instructions that when executed cause or direct performance of operations, the operations comprising:
obtaining an indication of mitigation work to be performed on a crop within an agricultural area using air movement;
obtaining a navigation path to follow within the agricultural area based on the mitigation work to be performed;
directing movement of an air blower system along the navigation path, the air blower system configured to circulate air among the crops along the navigation path;
obtaining data from one or more sensors associated with the air blower system while the air blower system is moved along the navigation path, the data related to the mitigation work to be performed; and
directing adjustment of an operating condition of the air blower system based on the data from the one or more sensors.

9. The computer-readable medium of claim 8, wherein the operating condition includes one or more of: an air speed of the air configured to circulate, a speed of movement of the air blower system, a direction of the air, and a pattern of air movement.

10. The computer-readable medium of claim 8, wherein the operations further comprise obtaining other non-sensor data, wherein the adjustment of the operating condition of the air blower system is further based on the non-sensor data.

11. The computer-readable medium of claim 10, wherein the non-sensor data includes one or more of: weather data, historical data, and positional data.

12. The computer-readable medium of claim 8, wherein the operations further comprise determining, by the air blower system, the mitigation work to be performed on the crop based on obtained data, wherein the indication of the mitigation work to be performed is obtained from the determination.

13. The computer-readable medium of claim 8, wherein the indication of the mitigation work is obtained from a user.

14. The computer-readable medium of claim 8, wherein the operations further comprise determining, by the air blower system, the navigation path to follow within the agricultural area based on the mitigation work to be performed.

15. An air blower system, comprising:
a blower configured to blow air;
a drive train configured to move the air blower system;
one or more sensor configured to obtain data regarding an agricultural area; and
a processor coupled to the blower, the drive train, and the sensors, the processor configured to perform operations, the operations including:
obtaining an indication of mitigation work to be performed on a crop within the agricultural area using air movement;
obtaining a navigation path to follow within the agricultural area based on the mitigation work to be performed;
directing the drive train to cause the air blower system to move along the navigation path;
obtaining the data from the sensors; and
directing adjustment of an operation of the drive train and/or the blower based on the data from the sensors.

16. The system of claim 15, wherein the operating condition includes one or more of: an air speed of the air configured to circulate, a speed of movement of the air blower system, a direction of the air, and a pattern of air movement.

17. The system of claim 15, wherein the operations further comprise obtaining other non-sensor data, wherein the adjustment of the operating condition of the air blower system is further based on the non-sensor data.

18. The system of claim 17, wherein the non-sensor data includes one or more of: weather data, historical data, and positional data.

19. The system of claim 15, wherein the operations further comprise determining, by the air blower system, the mitigation work to be performed on the crop based on obtained data, wherein the indication of the mitigation work to be performed is obtained from the determination.

20. The system of claim 15, wherein the indication of the mitigation work is obtained from a user.
